(19) United States
(12) Patent Application Publication
(10) Pub. No.: US 2017/0057630 A1
(43) Pub. Date: Mar. 2, 2017

(54) AIRCRAFT

(71) Applicant: IAT 21 INNOVATIVE AERONAUTICS TECHNOLOGIES GMBH, LINZ (AT)

(72) Inventor: Meinhard Schwaiger, Linz (AT)

(73) Assignee: IAT 21 INNOVATIVE AERONAUTICS TECHNOLOGIES GMBH, LINZ (AT)

(21) Appl. No.: 15/119,812

(22) PCT Filed: Feb. 17, 2015
(86) PCT No.: PCT/EP2015/053294

§ 371 Date: Sep. 14, 2016

(30) Foreign Application Priority Data
Feb. 18, 2014 (AT) A 50121/2014

(51) Int. Cl. B64C 29/00; B64C 3/56; B64C 27/02; B64C 39/02; B64D 27/04; B64D 27/24; B64C 3/38; B64C 27/20

(52) U.S. Cl. CPC B64C 29/0033; B64C 3/385; B64C 3/56; B64C 27/20; B64C 39/024; B64D 27/04; B64D 27/24; B64C 27/026; B64C 2201/027; B64C 2201/042; B64C 2201/044; B64C 2201/102; B64C 2201/108; B64D 2211/00; B64D 2027/026

(57) ABSTRACT

The invention relates to an aircraft comprising a fuselage (1), a plurality of propeller units (3) that can pivot in relation to the fuselage (1), and wings (5) that can pivot at least partially in relation to the fuselage (1) and independently of the propeller units (3).

The present invention relates to an alternative VTOL aircraft, which can take off and land vertically, assume a hovering state, rotate about any spatial axis, move in any direction in the air, and achieve a higher flight velocity in forward flight with higher efficiency than known helicopters and quadrocopters/multi-copters. The aircraft according to this invention essentially consists of an aircraft fuselage, on which multiple, preferably 3 to 10 propeller units, can be pivoted independently of one another about an axis perpendicular to the axis of rotation of the propellers. In a further preferred embodiment, the aircraft fuselage is supplemented with a pivotable wing unit, which provides the aircraft with a flight characteristic similar to a planar aircraft in forward flight.

Aircraft embodied as quadrocopters (z. B. KR 101199536, EP 2497555 D'Haeryer Frederic), U.S. 2011/0299732 (Jonchery Claire), WO 2013/1445078 (Callou Francois), KR 20120065546 (Joo Byung Kyu), KR 100812756 (Kang Min Sung), KR 100812755 (Kang Min Sung), CZ 26152 (Klekner Ota), CN20132236591 (Chen Jiayan), RU 2500577 (Kuzmich Borzenko Jakov)) having four propeller units or multi-copters having more than four propeller units, which are each rigidly connected to the aircraft, correspond to the prior art. The thrust and the rotor torque per propeller is varied and the aircraft is controlled by individual variation of the propeller speed or pitch. It can therefore take off and land vertically in a defined manner, rotate about the vertical axis, or be pivoted about a transverse axis and flown in a defined direction. In this case, the vertical lift is also generated via the propellers in forward flight and a proportional force component is used for the actual forward flight by inclination of the entire aircraft about a defined angle. Such systems have the disadvantage of the comparatively small proportion of force which can be utilized for forward flight and the low forward velocity and/or low efficiency linked thereto.

A configuration is known from KR 20120060590 (Jung Seul), in which the propeller units can be pivoted by 90° in relation to the vertical axis of the aircraft, so that the aircraft can be displaced in a defined direction on the ground by means of the freely rotating wheels of the chassis. In the flight state, the vertical lift is generated in a known manner via the propeller units according to this description.

A configuration is known from CN 103359283 (Xian Bin), in which the aircraft is embodied having three propeller units, which can additionally be pivoted.

A configuration having four rotors is known from DE 202013008284 (Borner Siegfried), wherein three smaller rotors are arranged in a lower plane and one larger rotor is arranged in a plane located above it. By means of additional flow guiding units below the smaller rotors and/or via a pivot movement of the smaller rotors, the aircraft can additionally be controlled in a defined flight direction.

A quadrocopter configuration is known from ES 2326201 (Porras Vila), which displays four rigidly arranged propeller units and four pivotable flow guiding units below the propeller units, so that the air flow of the propeller can be controlled toward the front or toward the rear. The flow guiding units are not suitable as airfoils, however.

An aircraft configuration is known from U.S. Pat. No. 5,000,398 (Rashev Michael S.), in which the vertical lift is generated using rigidly arranged rotor units and a forward thrust can be generated using additional engines. The fuselage of the aircraft is provided for accommodating a larger load (for example, an aircraft) and airfoils in the actual meaning are absent.

An aircraft configuration is known from U.S. Pat. No. 5,419,514 (Ducan Tery A.), which is embodied having an aircraft fuselage having four airfoils, on the ends of each of which a pivotably embodied ducted fan is arranged. The airfoils are rigidly connected to the aircraft fuselage.

An aircraft configuration is known from EP 2 690 012 (Fink Axel), which is embodied having an aircraft fuselage, on which a main rotor is provided approximately in the mass center of gravity, and having four airfoils, on each of the front two ends of which a pivotably embodied ducted fan is arranged. The airfoils are rigidly connected to the airfoil fuselage.

An aircraft configuration is known from EP 2 690 011 (Fink Axel), which is embodied having an aircraft fuselage, on which a main rotor is provided approximately in the mass center of gravity, and having four airfoils, on each of the front larger airfoils of which a propeller is rigidly arranged in the flight direction. The airfoils are rigidly connected to the airfoil fuselage.

An aircraft configuration is known from EP 2 690 010 (Fink Axel), which is embodied having an aircraft fuselage, on which a main rotor is provided approximately in the mass center of gravity, and having two airfoils, which are connected via a double fuselage, on each of the rear airfoils of which a thrust propeller is rigidly arranged. The airfoils are rigidly connected to the aircraft fuselage.

An aircraft configuration is known from EP 2 666 718 (Eglin Paul), which is embodied having an aircraft fuselage, on which a main rotor, embodied as a coaxial rotor, is provided approximately in the mass center of gravity, and having four airfoils, on the front larger airfoils of which a propeller is rigidly arranged in the flight direction. The airfoils are rigidly connected to the aircraft fuselage.

An aircraft configuration is known from RU 2502641 (Durov Dmitrij Sergeevich), which is embodied from two aircraft fuselages arranged in parallel, on which three rotors are arranged, and having airfoils, on the rear airfoils of which ducted fans are rigidly arranged and generate a forward thrust. The airfoils are rigidly connected to the aircraft fuselage.

An aircraft configuration is known from KR 20130126756 (Kroo Ilan), which is embodied having an aircraft fuselage, on which multiple vertical propellers arranged in series are arranged laterally, and having four airfoils, on each of the rear two airfoils of which a propeller is rigidly arranged. The airfoils are rigidly connected to the aircraft fuselage.

A flying wing design is known from CN 103318410 (Wang Jin), which is embodied having two pivotable propellers and can execute vertical takeoff and landing and also forward travel.

An aircraft configuration is known from U.S. 20130327879 (Scott Mark W.), which is embodied as a helicopter having a main rotor and a tail rotor, which can be pivoted about its axis of rotation. The pivotable tail rotor stabilizes the aircraft hovering state and can additionally generate horizontal thrust in the flight direction.

An aircraft configuration is known from RU 2500578 (Nikolaevich Pavlov Sergej), which is embodied having an aircraft fuselage, on which a main rotor is provided approximately in the mass center of gravity, having two propeller units, which are arranged in the front region laterally in relation to the aircraft fuselage and in parallel to the flight direction, for the forward thrust, and having two pivotable airfoils in the rear region.

Multiple aircraft configurations are known from WO 2003/029075 (Milde Karl F. Jr.), in which rigid airfoils are arranged on an aircraft fuselage and multiple ducted fans are connected to the airfoils or integrated into the airfoils, respectively, these ducted fans additionally being embodied having flow guiding units.

An aircraft is known from DE 1481620 (Lariviere Jan Soulez), in which two rigid airfoils are arranged on the aircraft fuselage, on the ends of each of which a pivotable ducted fan is arranged, which enables vertical takeoff and landing and also forward flight, but not a stable transition from the hovering state into the forward flight.

An aircraft is known from U.S. Pat. No. 8,016,226 (Wood Victor A.), which consists of an aircraft fuselage having integrated rigid airfoils, in which four pivotably mounted ducted fans are integrated and ailerons and elevators are provided for stabilization in forward flight. In this configuration, the rigid airfoils cause a high flow resistance in vertical climb.

An aircraft configuration is known from U.S. Pat. No. 8,152,096 (Smith Frick A.), which consists of an aircraft fuselage having rigid airfoils and is additionally equipped on the fuselage and on two additional airfoils in the front part of the aircraft with pivotable ducted fans. In this configuration, the rigid airfoils cause a high flow resistance in vertical climb and result in instability.

An aircraft configuration is known from U.S. Pat. No. 6,892,980 (Kawai Hideharu), which consists of an aircraft fuselage and two lateral elongated rigid airfoil structures, which form four corners, on each of which a pivotable jet engine is arranged. In a second embodiment variant, multiple engines oriented downward are arranged in the wing root of a conventional passenger aircraft. In this configuration, the rigid airfoils cause a high flow resistance in vertical climb and result in instability.

An aircraft configuration is known from U.S. Pat. No. 3,335,977 (Melitz Ludwig F.), in which two rigid airfoils are arranged on the aircraft fuselage, in the middle region of each of which a pivotable ducted fan is arranged, which enables vertical takeoff and landing and also forward flight, but not a stable transition from the hovering state into forward flight.

An aircraft configuration is known from U.S. Pat. No. 3,360,217 (Trotter John C.), on which four rigid airfoils are arranged on the aircraft fuselage, on the ends of each of which a pivotable ducted fan is arranged, which enables vertical takeoff and landing and also forward flight, but not a stable transition from the hovering state into forward flight. Additional jet engines are integrated in the rear airfoils for forward flight.

An aircraft is known from AT 503689 (Naderhirn Michael), consisting of a rigid flying wing fuselage having three pivotable engines integrated into the airfoil.

An aircraft configuration is known from U.S. Pat. No. 3,084,888 (Hertel H.), in which two rigid airfoils and multiple engines are arranged on the aircraft fuselage, which can be pivoted and enable vertical takeoff and landing and also forward flight.

An aircraft configuration is known from DE 1926568 (Nachod James Henning), in which two rigid airfoils are arranged on the aircraft fuselage, on the ends of which pivotable propellers are located, and engines for forward thrust are arranged in the tail region of the aircraft, so that vertical takeoff and landing and also forward flight are possible, but not a stable transition from the hovering state into forward flight.

An aircraft configuration is known from U.S. 20130256465 (Smith Dudley E.), in which two rigid airfoils are arranged on the aircraft fuselage, on the ends of which pivotable rotors are arranged, which enable vertical takeoff and landing and also forward flight, but not a stable transition the hovering state into forward flight.

An aircraft configuration is known from WO 2005/037644 (Dzerins Peteris), embodied as a multi-copter having pivotably arranged propellers, so that vertical takeoff and landing and also forward flight are possible, but not gliding flight, because wing units are absent.

An aircraft configuration is known from DE 102011113731 (Euer Hartmut), in which two rigid airfoils are arranged on the aircraft fuselage, which support pivotable engines, and further pivotable engines are provided on the aircraft fuselage in the rear region, so that vertical takeoff and landing and also forward flight are enabled and also a stable transition from the hovering state into forward flight.

An aircraft configuration is known from EP 2 669 195 (Euer Hartmut), in which multiple drive rotors are arranged on pivot arms on the aircraft fuselage, which enable vertical takeoff and landing and also forward flight, and the drive rotors press against the fuselage for the airfoil in a second position or are accommodated in the fuselage or the airfoil and which is embodied having a vertical and lateral tail unit for stabilization in the flight phase. In a further embodiment variant, the airfoil is pivotable about an axis transverse to the longitudinal axis of the aircraft.

All known aircraft configurations have the disadvantage of the lack of efficiency in forward flight and/or the absence of complete 360° maneuverability about every spatial axis and/or the stable transition from the hovering state into forward flight.

The object of the present invention is to define an aircraft, which can take off and land vertically, assume a hovering state, rotate about every spatial axis, move in any direction in the air, and achieve a higher flight velocity at higher efficiency in forward flight than known helicopters and quadrocopters/multi-copters. The aircraft is to be as compact as possible during takeoff and during landing. The aircraft is to enable safe landing by way of autorotation capability for the case of failure of the propeller units as a result of a component failure or a lack of fuel.

This object is achieved according to the invention in that the airfoils are pivotable at least partially in relation to the aircraft fuselage and independently of the propeller units.

Because multiple propeller units are arranged so they are pivotable in relation to a rigid aircraft fuselage and the individually generated thrust vectors can be guided in any arbitrary direction, the direction of the thrust vector is aligned approximately in parallel to the flight direction in forward flight. With additionally provided airfoils on the fuselage, the required lift is generated in forward flight and a higher efficiency is achieved in forward flight in relation to known helicopters and quadrocopters/multi-copters. In a further preferred embodiment variant, the airfoils are pivotable about an axis of rotation, so that in vertical climb (vertical takeoff) and/or during the landing maneuver, a higher efficiency and precision can be achieved.

The number of the propeller units is 3 to 10, so that a stable flight attitude is possible during vertical takeoff and vertical landing, in the hovering state, and in the transition range from the hovering state into forward travel or from forward travel into the hovering state, respectively, in contrast to alternative aircraft having only two propeller units, in which the stability is first enabled in the flight attitude above a critical flight velocity.

Furthermore, the failure of a single propeller can be tolerated better with a higher number of propeller units.

The propeller units are preferably provided within airfoils. The arrangement of the propeller units within airfoils enables targeted influencing of the aerodynamics of the aircraft.

The alternatively provided arrangement of the propeller units within the overall aircraft structure or within the airfoils, respectively, enables a moderate collision with obstructions without risk of damage to the aircraft (for example, touching rock walls, docking on vertical walls, flying through small openings in buildings, for example, windows, . . . ).

The arrangement of the propeller units within a protective frame increases the safety of the aircraft in the event of moderate collision with obstructions, but also enables touching of the aircraft in operation without risk of injury to persons.

In the preferred embodiment variant, the propeller units are arranged so they are pivotable in relation to the aircraft fuselage about a pivot angle which is approximately 90° in both directions starting from a middle position. Therefore, in addition to vertical takeoff and landing and in forward flight, a thrust reversal is possible, which enormously improves the agility, on the one hand, but also enables suctioning onto a fixed underlying surface.

The propeller units are pivotable in relation to the aircraft fuselage about a pivot axis, which is arranged in parallel to the transverse axis of the aircraft, and this is true independently for each individual propeller unit, so that the most extreme flight maneuvers and turning with very small turning radii are enabled.

Assistance of the agility and maneuverability of the aircraft is achieved in that the propeller units are gimbal mounted in relation to the aircraft fuselage.

An increase of the failure safety and a reduction of the complexity of the aircraft are enabled in that the propeller units are electrically driven and can be individually controlled.

A simplified power transmission to the individual propeller units is possible by way of electrical power supply. As a result of the limited capacitances and the high weights of present typical electrical accumulators (batteries), a hybrid power supply, consisting of fuel cells or internal combustion engine and generator for generating electrical energy, is provided in a further embodiment variant.

Ranges and usage times of both manned and also unmanned aircraft are of enormous significance, because of which solar cells are also provided for generating electrical energy.

Ranges and usage times having autonomous power supply on board are advantageously possible by means of propeller units which are driven by at least one internal combustion engine.

The increased agility of the aircraft, on one hand, and also the high efficiency in forward flight is possible in that the airfoils are pivotable about an axis in relation to the aircraft fuselage, which axis is arranged in parallel or at an acute angle in relation to the transverse axis of the aircraft and, in economical forward flight, the airfoil is adjusted at an adjustment angle which enables the most minimal possible flow resistance with optimum lift.

Takeoff and landing in extremely constricted space and also a particularly small radar signature are provided in that the airfoils are arranged so they are collapsible.

Reaching higher altitudes than using known helicopters/quadrocopters/multi-copters is possible in that the airfoils can be moved into a helical pivoted position, in which in the event of a rotation of the aircraft about its vertical axis and/or about an axis parallel to the vertical axis, but outside the aircraft, vertical lift is generated for a climb with low energy use (similarly to an eagle “spiraling” in the air).

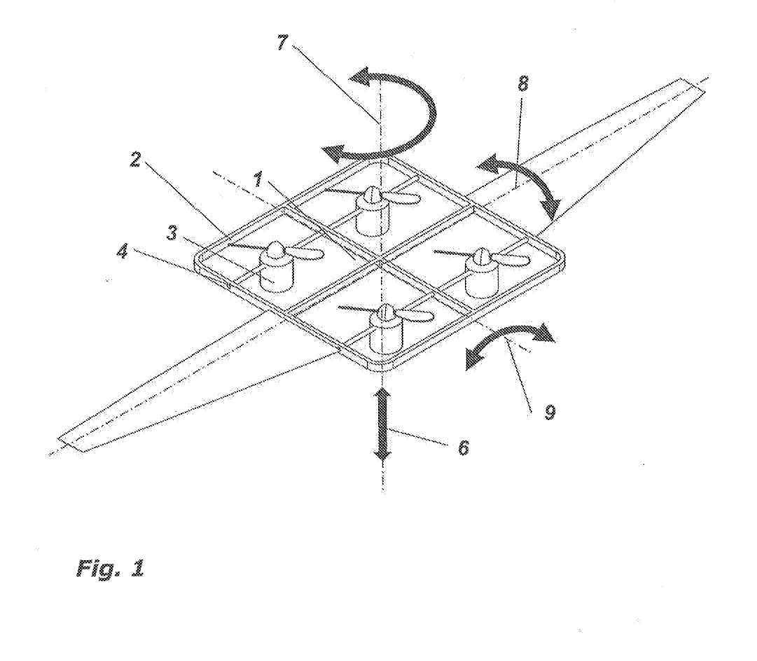

The invention will be described in greater detail hereafter on the basis of Figures 1 to 5:

FIG. 1 shows an aircraft according to the invention, consisting of an aircraft fuselage 1, an outer protective frame 2 (not absolutely required), multiple, preferably 4 propeller units 3, a pivot unit 4 for each propeller unit 3, the flight direction 6, which is definable by the position of the propeller units and the possible rotational movements of the aircraft about the vertical axis 7, transverse axis 8, and longitudinal axis 9.

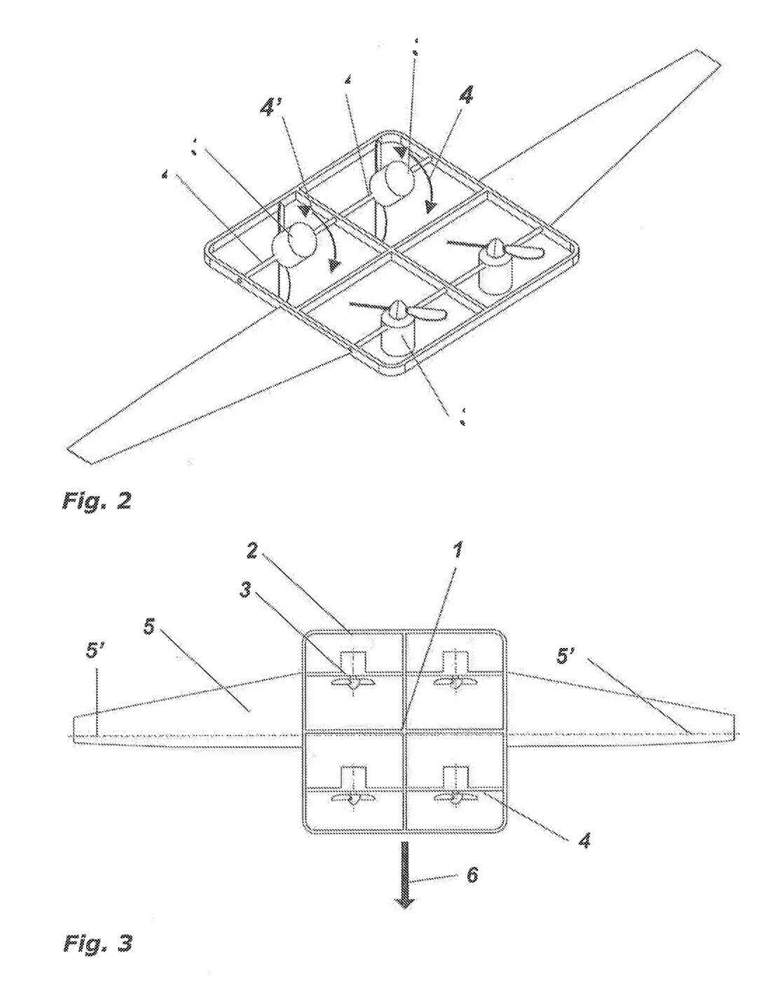

FIG. 2 shows the aircraft according to the invention, having the pivot unit 4 and the pivot movement 4′ of the propeller unit 3, wherein the pivot angle can be greater than +−180°.

FIG. 3 shows the aircraft according to the invention in a view from above in an embodiment variant having airfoils 5, which are rigid or, according to a further embodiment variant, can be pivoted along a pivot axis 5′ about a pivot angle 5″, preferably in the range +/−90°. The aircraft is located in the flight direction 6 in forward travel and the propeller units 3 are aligned in the flight direction.

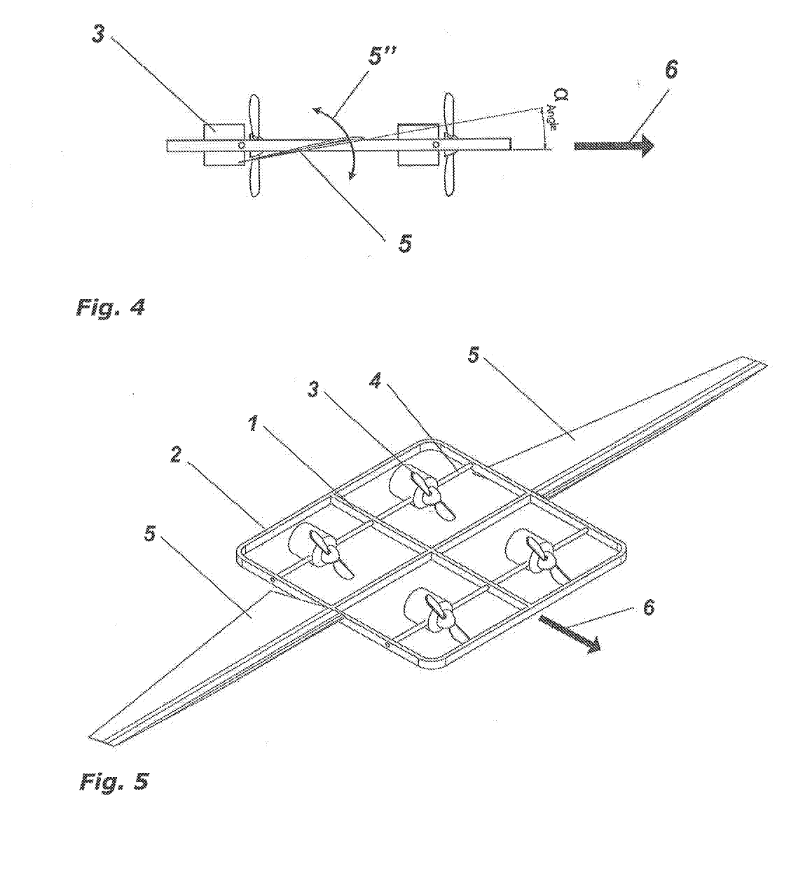

FIG. 4 shows the aircraft according to the invention according to FIG. 3 in a side view. The airfoils 5 are adjusted by the adjustment angle 5″ opposite to the flight direction for optimum lift generation.

FIG. 5 shows the aircraft according to the invention in optimum forward flight having adjusted airfoils 5, which are arranged on the aircraft fuselage 1. The propeller units 3 and the pivot unit 4 can be protected by a protective frame 2. The aircraft fuselage 1 and the protective frame 2 can have an aerodynamic shape.

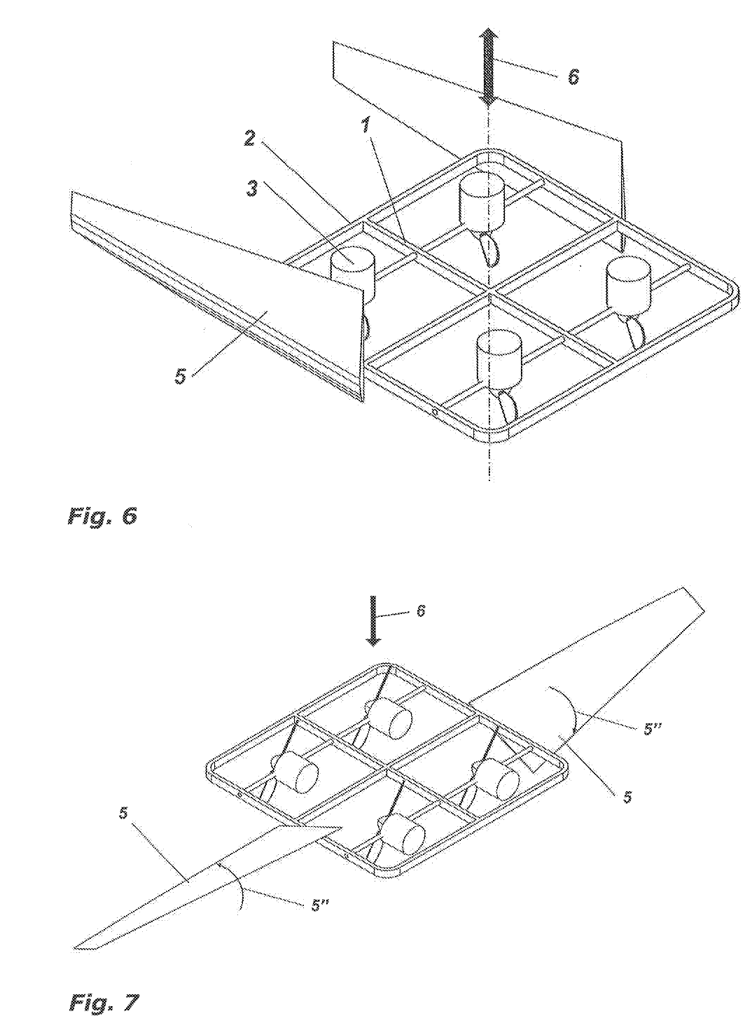

FIG. 6 shows the aircraft according to the invention having laterally collapsed airfoils for particularly small external dimensions, for example, as can be required for a landing maneuver in an extremely small space.

FIG. 7 shows the aircraft according to the invention having airfoils adjusted in opposite directions, so that the aircraft can be set into a rotation about the vertical axis, to be moved vertically similarly to a propeller or, in the event of a failure of the propeller units, can simultaneously be set into rotation about the vertical axis in the freefall downward 6 in the vertical direction and can absorb an impact by counter action in a timely manner of the airfoil inclination while utilizing the rotational energy.

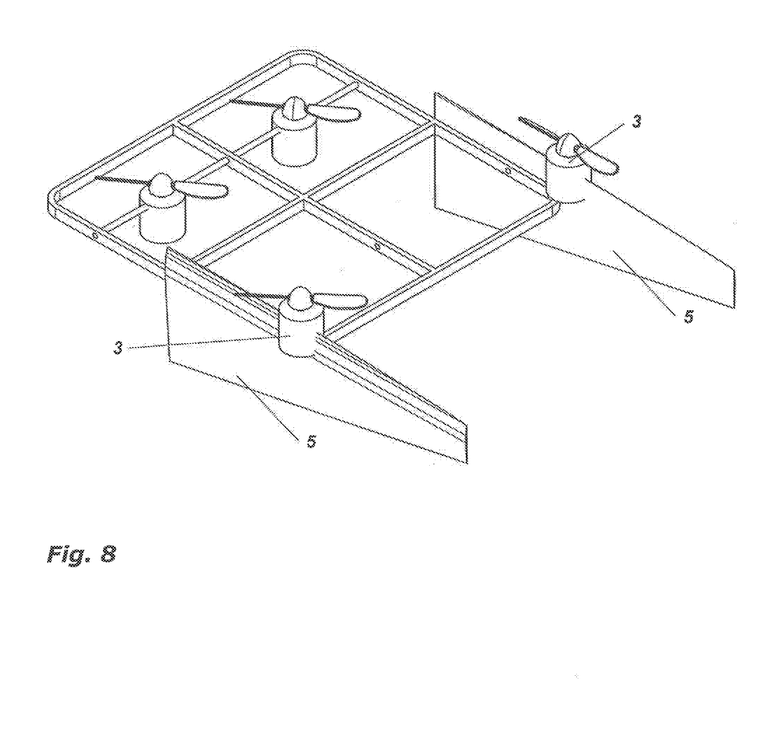

FIG. 8 shows the aircraft according to the invention in a further embodiment variant, in which individual propeller units 3 are arranged directly on the airfoil, having collapsed airfoil for stable standing on the ground, for example, during a takeoff procedure or during a safe landing in a small space.

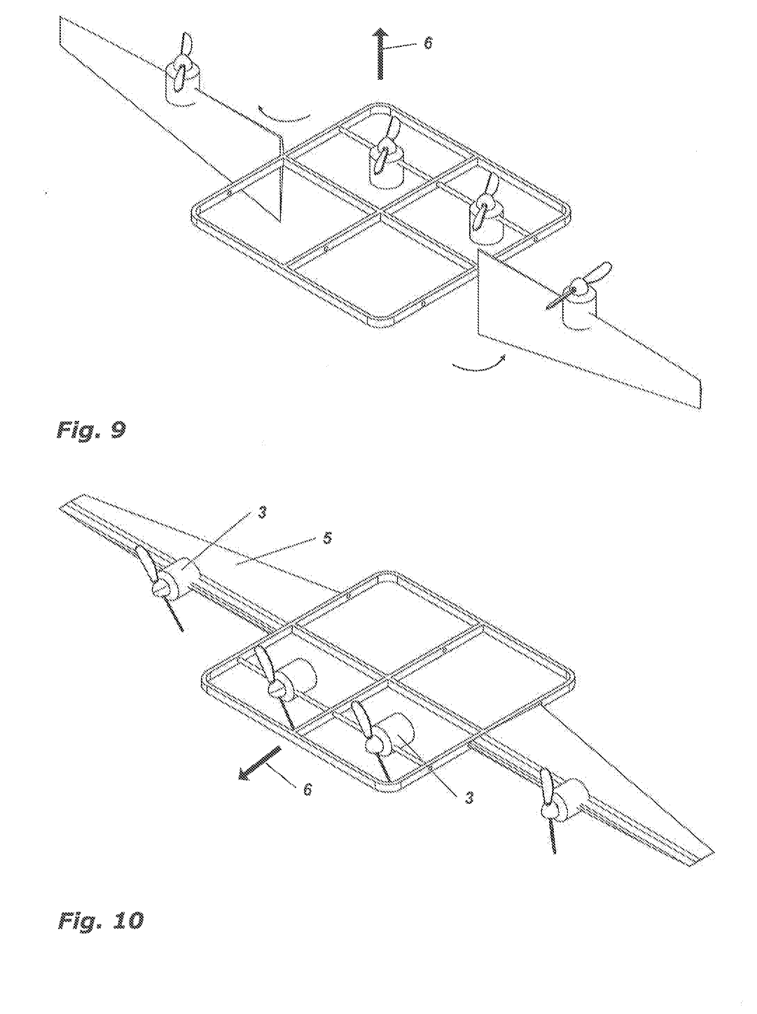

FIG. 9 shows the aircraft according to the invention in the further embodiment variant according to FIG. 8, in which individual propeller units 3 are arranged directly on the airfoil and the airfoils have been unfolded after the takeoff procedure.

FIG. 10 shows the aircraft according to the invention in the further embodiment variant according to FIG. 8, in which individual propeller units 3 are arranged directly on the airfoil and the airfoils have been unfolded after the takeoff procedure, in forward flight, wherein the aircraft behaves in this flight phase similarly to a classical planar aircraft (for example, powered glider) having low flow resistance.

An essential aspect of the invention is also that the aircraft can be embodied free of tails or stabilization surfaces.

1. An aircraft having an aircraft fuselage and multiple propeller units, which are arranged so they are pivotable in relation to the aircraft fuselage, and having airfoils, which are at least partially pivotable in relation to the aircraft fuselage and independently of the propeller units, wherein the propeller units are provided within airfoils or within the aircraft fuselage.

2. The aircraft according to claim 1, wherein 3 to 10 propeller units are provided.

3. The aircraft according to claim 1, wherein the propeller units each have a protective frame.

4. The aircraft according to claim 1, wherein the propeller units are pivotable in relation to the aircraft fuselage about a pivot angle which is approximately 90° in both directions starting from a middle position.

5. The aircraft according to claim 1, wherein the propeller units are pivotable in relation to the aircraft fuselage about a pivot axis, which is arranged in parallel to the transverse axis of the aircraft.

6. The aircraft according to claim 1, wherein the propeller units are gimbal mounted in relation to the aircraft fuselage.

7. The aircraft according to claim 1, wherein the propeller units are electrically driven, and preferably solar cells are provided for generating electrical energy.

8. The aircraft according to claim 7, wherein a hybrid power supply is provided, consisting of fuel cells or internal combustion engine and generator for generating electrical energy.

9. The aircraft according to claim 1, wherein the propeller units are driven by at least one internal combustion engine.

10. The aircraft according to claim 1, wherein the airfoils are pivotable in relation to the aircraft fuselage about an axis which is arranged in parallel or at an acute angle in relation to the transverse axis of the aircraft.

11. The aircraft according to claim 1, wherein the airfoils are arranged in a collapsible manner.

12. The aircraft according to claim 1, wherein the airfoils can be moved into a helical pivoted position, in which lift is generated during a rotation of the aircraft about its vertical axis.

13. The aircraft according to claim 1, wherein the event of a failure of individual drive units, the aircraft is put into autorotation by mutual pivoting of the airfoils and vertical sinking of the aircraft and an impact on the ground can be moderated in that the airfoils are adjusted in a timely manner opposite to the first pivot and a lift can be generated by the rotational energy.

14. The aircraft according to claim 1, wherein propeller units can be arranged in a rigid or movable manner on the airfoil.

15. The aircraft according to claim 1, wherein the aircraft can assume a stable stand on the ground by means of the airfoil.

16. The aircraft according to claim 1, wherein aircraft can take off vertically having collapsed airfoils and can unfold the airfoils in the hovering state, wherein the aircraft can preferably transition from the hovering state into stable forward flight and can assume a high flight velocity with extremely minimal flow resistance.
